(19) United States
(12) Patent Application Publication
(10) Pub. No.: US 2011/0213038 A1
(43) Pub. Date: Sep. 1, 2011

(54) CONTROL OF BED BUGS

(76) Inventor: Robert H. Bedoukian, West Redding, CT (US)

(21) Appl. No.: 12/998,513

(22) PCT Filed: Oct. 29, 2009
(86) PCT No.: PCT/US09/05874

§ 371 Date: Apr. 28, 2011

Related U.S. Application Data
(60) Provisional application No. 61/197,709, filed on Oct. 30, 2008.

(51) Int. Cl. A01N 35/02; A01N 31/02; A01P 7/04

(52) U.S. Cl. 514/678; 514/739

(57) ABSTRACT

Control of bed bugs by bringing the bed bugs into contact with a bed bug control formulation containing at least one of carvone, linalool, styralyl alcohol, dihydrocarvone, tetrahydrocarvone, and mixtures thereof and method for achieving such control.

### FIELD OF THE INVENTION

This invention relates to compositions and methods for the control of bed bugs.

### BACKGROUND TO THE INVENTION

There have been a number of publications regarding various characteristics of bed bugs. See generally C. Johnson, The ecology of the bed-bug, Cimex lectularius L., 41 Journal of Hygiene 345-461 (1942); H. Levinson et al., Assembling and alerting scents produced by the bedbug, Cimex lectularius L., 27 Experientia: 102-103 (1971); H. Levinson et al., Action and composition of the alarm pheromone of the bedbug Cimex lectularius L., 61 Naturwissenschaften 684-685 (1974); H. Levinson et al., Structure of sensilla, olfactory perception, and behavior of the bedbug, Cimex lectularius, in response to its alarm pheromone, 20 Journal of Insect Physiology 1231-1248 (1974); K. Mellanby, The physiology and activity of the bed-bug (Cimex lectularius) in a natural infestation, 31 Parasitology 200-211 (1939); and H. Schmitz et al., The ability of Rhodnius prolixus (Hemiptera; Reduviidae) to approach a thermal source solely by its infrared radiation, 46 Journal of Insect Physiology 745-751 (2000).

Bed bugs feed on human blood. Thus, bed bugs are not merely unsightly, they leave ugly skin markings. However problematic this is for residential bedrooms, it is an even more serious problem for motels and the like. With respect to such commercial bedrooms there is more opportunity for external infection sources to bring bed bugs to the site, and should there be an unknown infestation which causes biting of customers before it is dealt with, there is a severe risk of customer dissatisfaction and adverse publicity, likely leading to a long term significant reputation loss.

Recent data suggests bedbug infestations (Cimex species) of human domiciles are on the rise. At least 92 species of bed bugs have been identified globally, of which at least 16 species are in the North American continent. Generally, bed bugs are parasitic pests with its hosts including humans and various domesticated animals. It is believed that bedbug infestations are becoming more problematic now at least in part because long acting, residual insecticides are no longer being used to keep bedbug populations in check. In addition, increased international travel and insecticide resistance have made bedbug infestations spread and control with insecticides very difficult. In terms of scale, such infestations are of particular concern for hoteliers, cruise ships, trains, daycare facilities, and the like because of the business reputation risk posed by bad press or bad reviews. Other problematic areas tend to include nursing homes, barracks, dorms, hospitals, and various other forms of high density housing. Nonetheless, single family homes can likewise be impacted adversely.

There have been attempts to control bedbug infestation through applications of insecticidal chemicals to infected areas and materials (especially mattresses). This approach has some drawbacks. For example, it can expose those using a treated area or mattress too soon after application to odor or other undesired characteristics of the pesticidal chemical. Further, unless the chemicals are used regularly, without regard to whether an infestation is known to already exist (which procedure will significantly increase costs), those sleeping in an infected area can be bitten before one knows to begin treatment.

Bed bugs had nearly been eradicated by the widespread use of potent insecticides such as DDT. However, many of these strong insecticides have been banned from the United States and replaced with weaker insecticides such as pyrethroids. Many bed bugs have grown resistant to the weaker insecticides. In a study at the University of Kentucky bed bugs were randomly collected from across the United States. These “wild” bed bugs were up to several thousands of times more resistant to pyrethroids than were laboratory bed bugs. Another problem with current insecticide use is that the broad-spectrum insecticide sprays for cockroaches and ants that are no longer used had a collateral impact on bedbug infestations. Recently, a switch has been made to bait insecticides that have proven effective against cockroaches but have allowed bed bugs to escape the indirect treatment.

The number of bedbug infestations has risen significantly since the early 21st century. The National Pest Management Association has reported a 71% increase in bedbug calls between 2000 and 2005. The Steritech Group, a pest-management company based in Charlotte, N.C. claimed that 25% of the 700 hotels they surveyed between 2002 Chicago were awarded $372,000 in punitive damages after being bitten by bed bugs during

With the widespread use of DDT in the 1940s and 1950s, bed bugs all but disappeared from North America in the mid-twentieth century. Infestations remained common in many other parts of the world and in recent years have also begun to rebound in North America. Reappearance of bed bugs has presented new challenges for pest control without DDT and similarly banned agents.

Another reason for the increase in bed bugs is that pest control services more often nowadays use low toxicity gel-based pesticides for control of cockroaches, the most common pest in structures, instead of residual sprays. When residual sprays meant to kill other insects were commonly being used, they resulted in a collateral insecticidal effect on potential bedbug infestations; the gel-based insecticides primarily used nowadays do not have any effect on bed bugs, as they are incapable of feeding on these baits.

There is, therefore, a need for safe and effective chemicals to control bed bugs and for safe and effective means to employ such chemicals for the control of bed bugs.

### SUMMARY OF THE INVENTION

Safe and effective control of bed bugs can be accomplished with the use of formulations containing at least one compound selected from carvone, linalool, styralyl alcohol, dihydrocarvone, tetrahydrocarvone, and mixtures thereof such that bed bugs come into contact with vapors of such compound(s). The compounds may be present in any of their enantiomeric forms or as mixtures of their enantiomers. Further aspects of this invention relate to the use of such formulations in various methods for the control of bed bugs. Among the various methods in which the formulations of this invention may be employed are (1) injecting the formulations into a mattress, either directly or in combination with other ingredients or solvents, (2) placing the formulations on an absorbent material and placing the absorbent material in a sachet and placing the sachet containing the formulation into a locus such as a mattress, hamper, suitcase, clothing bag, linen storage closet or any other enclosure where bed bugs may be present, (3) preparing “dryer sheets” containing the formulations for placement in a locus such as a mattress, suitcase, clothing bag, hamper, linen storage closet, or any other enclosure where bed bugs are likely to be present, or in a pile of clean, or soiled or dirty laundry, and (4) placing the formulation into detergent or fabric softener compositions for controlling bed bugs during use of these compositions in cleaning clothes.

### DETAILED DISCLOSURE OF THE INVENTION

Safe and effective control of bed bugs can be accomplished with the use of formulations containing at least one compound selected from the group of carvone, linalool, styralyl alcohol, dihydrocarvone, tetrahydrocarvone, and mixtures thereof such that bed bugs come into contact with vapors of such compound(s).

An embodiment of the invention comprises a method for control of bed bugs by bringing the bed bugs into contact with a bed bug control formulation containing at least one compound selected from carvone, linalool, styralyl alcohol, dihydrocarvone, tetrahydrocarvone, and mixtures thereof such that the bed bugs come into contact with the vapors of the compound(s). The compounds may be present in any of their enantiomeric forms or as mixtures of their enantiomers. The carvone may be present as a component of spearmint or caraway oil. Another embodiment of this invention comprises a method for control of bed bugs by placing into an area suspected of possibly containing bed bugs a formulation containing at least one compound selected from -carvone, linalool, styralyl alcohol, dihydrocarvone, tetrahydrocarvone, and mixtures thereof such that the bed bugs come into contact with the vapors of the compound(s). Further embodiments of the invention comprise the aforesaid methods wherein the formulation is injected into a mattress. Yet another embodiment of the invention comprises the aforesaid methods wherein the formulation is on an absorbent material located in a sachet placed into the suspected area such as a mattress, hamper, suitcase, clothing bag, linen storage closet, or other enclosure where bed bugs may be present. A still further embodiment of the invention comprises the aforesaid methods wherein the formulation is included in a detergent or fabric softener composition. An even still further embodiment of the invention comprises the aforesaid methods wherein the formulation is included in a form similar to a dryer type sheet which may be placed in a mattress, hamper, suitcase, clothing bag, linen storage closet, or in piles of clothes, including dirty or soiled laundry. An aspect of this invention is the use of such formulation in control methods whereby there is significant mortality of bed bugs, especially within 72 hours or less. Dryer sheets are paper or cloth like sheets generally about one square foot in area that are put into clothes dryers to eliminate static, soften fabrics and add fragrance. A similar dryer type sheet product may be made using the compounds embodied in this invention in place of or in addition to the fragrance. The large surface area of the dryer type sheets will be ideal to promote rapid volatilization of the active ingredients into the areas where bed bugs may be present.

The active compound(s) of this invention, namely, carvone, linalool, styralyl alcohol, dihydrocarvone, tetrahydrocarvone, and mixtures thereof, may be employed with any suitable carrier material. The compounds of the formulations of this invention may also be used in conjunctions with fragrances, detergents, fabric softeners, as well as with other pesticides with which they may exhibit a synergistic or other beneficial effect.

As used herein, the term “carrier” refers to a material, which may be inorganic or organic and of synthetic natural origin, with which the active compound is mixed or formulated to facilitate its application to a locus or other object to be treated, or its storage, transport and/or handling. In general, any material that be customarily employed as a carrier in pesticidal formulations are suitable for use with the present invention. The pesticidal compositions provided herein may be employed alone or in the form of mixtures with such solid and/or liquid dispersible carrier vehicles. As used herein, “carriers” include conventional inert pesticide diluents or extenders of the type usable in conventional pesticide formulations or compositions, e.g., conventional pesticide dispersible carrier vehicles such as solutions, emulsions, suspensions, emulsifiable concentrates, spray powders, pastes, soluble powders, dusting agents, granules, foams, pastes, tablets, aerosols, natural and synthetic materials impregnated with active compounds, microcapsules, fumigating cartridges, fumigating cans and fumigating coils, as well as cold mist and warm mist formulations.

Examples of conventional carrier vehicles for use herein include, but are not limited to, aerosol propellants which are gaseous at normal temperatures and pressures, such as propane, butane, isobutene and carbon dioxide; inert dispersible liquid diluent carriers, including inert organic solvents, such as aromatic hydrocarbons, e.g., benzene, toluene, xylene, alkyl naphthalenes, halogenated aromatic hydrocarbons, cycloalkanes, e.g., cyclohexane, paraffins, e.g., petroleum or mineral oil fractions, chlorinated aliphatic hydrocarbons, e.g., methylene chloride, chloroethylenes, alcohols, e.g., methanol, ethanol, propanol, butanol, ethylene or propylene glycol, as well as ethers and esters thereof, e.g., glycol monomethyl ether, amines, e.g., ethanolamine, amides, e.g., dimethyl formamide, sulfoxides, e.g., dimethyl sulfoxide, acetonitrile, ketones, e.g., acetone, methyl ethyl ketone, methyl isobutyl ketone, cyclohexanone, and/or water, as well as inert dispersible finely divided solid carriers such as ground natural minerals, e.g., kaolins, clays, vermiculite, alumina, silica, chalk, i.e., calcium carbonate, talc, attapulgite, montmorillonite, kieselguhr, and ground synthetic minerals, e.g., highly dispersed silicic acid, and silicates, e.g., alkali silicates.

The formulations of this invention are formulated to provide a control effective vapor concentration in the locus being treated of from about 25 to about 600 ppm, more preferably in a concentration of from about 50 to about 400 ppm, and even more preferably in a concentration of from about 100 to about 300 ppm as limited by their vapor pressure at ambient temperature.

The utility and effectiveness of the invention is illustrated by, but not limited to, the following examples.

This test was undertaken employing unconcealed bed bugs. One drop (about 25-30 mg) of a naturally occurring aromatic test compound was applied to a filter paper and placed with a 16 oz. glass jar (3½ inches diameter×3⅞ inches high) containing ten adult bed bugs Cimex lectularius of both sexes. The jar was then sealed with a plastic lid. Five replicates of ten bed bugs were exposed to each of the test compounds. The test formulations were assessed for 24 hour mortality. A control jar with no test compound was also included in the testing. The results were as follows.

| Test | |
|---|---|
| Compound | 24 hr Mean Mortality % |
| Control | 2.0 |
| l-Carvone | 73.5 |
| l-Linalool | 100.0 |

The test was repeated with several other test compounds in the same manner:

| Test Compound | 24 hr Mean Mortality % |
|---|---|
| Control | 0.0 |
| d-Carvone | 47.8 |
| d-Linalool | 92.0 |
| Styralyl alcohol | 89.8 |
| Tetrahydrocarvone | 58.1 |

This test was conducted using concealed bed bugs. One drop (about 25-30 mg) of a naturally occurring aromatic test compound was applied to a filter paper and placed with a 16 oz. glass jar (3½ inches diameter×3⅞ inches high) containing ten adult bed bugs Cimex lectularius of both sexes. A piece of folded mattress ticking was also placed in the jar to allow the bed bugs a place to hide. The jar was then sealed with a plastic lid. Five replicates of ten bed bugs were exposed to each of the test compounds. Mortality was assessed at 72 hours. A control jar with no test compound was also included in the testing. The mortality results were as follows.

| Test Compound | 72 hr Mean Mortality % |
|---|---|
| Control | 2.0 |
| l-Carvone | 46.7 |
| l-Linalool | 68 |
| Styralyl alcohol | 91.8 |
| Tetrahydrocarvone | 16.7 |

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

1. A method for control of bed bugs comprising bringing the bed bugs into contact with vapors of a bed bug control formulation containing at least one compound selected from-carvone, linalool, styralyl alcohol, dihydrocarvone, tetrahydrocarvone, and mixtures thereof.

2. A method according to claim 1 wherein the formulation contains styralyl alcohol.

3. A method according to claim 1 wherein the formulation contains linalool.

4. A method according to claim 3 wherein the formulation contains 1-linalool.

5. A method according to claim 1 wherein the formulation contains carvone.

6. A method according to claim 5 wherein the formulation contains 1-carvone.

7. A method according to claim 1 wherein the formulation contains dihydrocarvone.

8. A method according to claim 1 wherein the formulation contains tetrahydrocarvone.

9. A method according to claim 1 wherein the formulation cause mortality of the bed bugs within 72 hours of contact with the vapor.

10. A method for control of bed bugs comprising placing into an area suspected of possibly contain bed bugs a formulation containing at least one compound selected from the group consisting of carvone, linalool, styralyl alcohol, dihydrocarvone, tetrahydrocarvone, and mixtures thereof so that bed bugs may be contacted with the vapor from the formulation so that direct contact with the liquid or formulated application method is not necessary.

11. A method according to claim 10 wherein the formulation is injected into a mattress.

12. A method according to claim 10 wherein the formulation is on an absorbent material located in a sachet placed into the suspected area.

13. A method according to claim 12 wherein the sachet is placed in a locus selected from a mattress, hamper, suitcase, clothing bag, or linen storage closet.

14. A method according to claim 10 wherein the formulation is included in a detergent or fabric softener composition.

15. A method according to claim 10 wherein the formulation is included in a dryer type sheet.

16. A method according to claim 15 wherein the dryer type sheet is placed in a locus selected from a mattress, hamper, suitcase, clothing bag, and linen storage closet.

17. A method according to claim 15 wherein the dryer type sheet is placed in a pile of clean or soiled laundry.

18. A method according to claim 10 wherein the formulation causes mortality of bed bugs within 72 hours of contact of the vapor with the bugs.
